(19) United States
(12) Patent Application Publication
(10) Pub. No.: US 2007/0080877 A1
(43) Pub. Date: Apr. 12, 2007

(54) Frame for radio frequency communication system

(76) Inventor: Douglas K. Ford, Fort Wayne, IN (US)

Correspondence Address: Douglas K. Ford;c/o Touchplate Technologies, Inc., P.O. Box 10960, Fort Wayne, IN, 46854, US

(21) Appl. No.: 11/233,694

(22) Filed: Sep. 23, 2005

(51) Int. Cl. H01Q 1/00

(52) U.S. Cl. 343/720; 343/702

(57) ABSTRACT

Disclosed is a frame for a radio frequency communication system. The frame has a frame central opening configured by an inner perimeter and an outer perimeter and a groove. The frame is capable of securely receiving and snugly retaining a circuit board of the radio frequency communication system in the frame central opening and a radio frequency antenna of the circuit board in the groove thereby enabling the radio frequency antenna to extend outside a perimeter of any metallic member of the radio frequency communication system and overcoming the negative field of the metallic members. The frame of the present invention allows a larger antenna with larger perimeter area to be achieved and provides an aesthetic look to the wall mountable radio communication systems.

### FIELD OF THE INVENTION

The present invention relates generally to radio frequency communication systems, and more particularly, to frames capable of receiving antennas for radio frequency communication systems.

### BACKGROUND OF THE INVENTION

Wall mountable radio frequency communication systems (e.g., wall switch assemblies) are well known and in widespread use. Such communication systems generally have a radio frequency antenna that is used for communication of signals for control of other devices, for example, communication equipments, motors (e.g., motors for garage doors), security systems, access control systems, telephone systems, appliances, heating/cooling systems, and the like. The radio frequency antenna, usually in a wire form, is connected with these communication systems, in such a way that a substantial portion of the radio frequency antenna is allowed to dangle outside the communication system, thereby giving these communication systems an un-attractive, aesthetically displeasing appearance. Moreover, difficulties are faced when installing the communication systems on walls, since a substantial portion of the antenna is outside the communication system. Also, the portion of the radio frequency antenna which is inside a framework of such communication systems is close to a negative field of other metallic members in the framework, resulting in weak communication of signals.

U.S. Pat. No. 5,936,581 discloses a radio frequency switch assembly mountable between an antenna port and a detachable antenna of a radio communication device assembly to provide an interface for a radio frequency accessory. The antenna port receives only a threaded portion of the antenna, and a much larger portion of antenna is outside the switch assembly, thereby giving the switch assembly an unattractive, aesthetically displeasing appearance, and also resulting in installation difficulties.

U.S. Pat. No. 4,286,335 discloses an apparatus having an integral coaxial antenna coupled via coaxial connector to its internal circuitry. The antenna is substantially outside the apparatus, thereby giving the apparatus an unattractive, aesthetically displeasing appearance.

Most of the prior art communication systems do not provide any means to wholly accommodate the radio frequency antenna within itself, and thus do not have an attractive and aesthetically pleasing appearance. Such prior art communication systems also suffer from installation difficulties, and weaker communication signals.

Therefore there exists a need for a radio frequency communication system that has means for wholly accommodating the radio frequency antenna there itself, thereby imparting an attractive and aesthetically pleasing appearance to communication system. Also, there exists a need for radio frequency communication system that can accommodate the radio frequency antenna in such a way as to avoid any installation problems due to the radio frequency antenna, and to result in enhanced communication signals.

### SUMMARY OF THE INVENTION

In view of the foregoing disadvantages inherent in the above-mentioned prior arts, the general purpose of the present invention is to provide an improved combination of convenience and utility, to include all the advantages of the prior arts, and to overcome the above-mentioned disadvantages/drawbacks of the prior art.

In one aspect, the present invention provides a frame for a radio frequency communication system. The frame has a central opening and a groove, capable of securely receiving and snugly retaining a circuit board of the radio frequency communication system in the central opening and a radio frequency antenna of the circuit board in the groove. The frame thereby enables the radio frequency antenna to extend outside a perimeter of any metallic member of the radio frequency communication system and overcomes the negative field of the metallic members.

In yet another aspect, the present invention provides a radio frequency communication system, the system comprises a circuit board with a radio frequency antenna, a frame, a sub-plate or a switch housing and a cover. The frame has a front surface, a back surface with a groove, and a frame central opening, the frame capable of securely receiving and retaining the circuit board in the frame central opening thereby enables the radio frequency antenna to snugly fit into the groove. The sub-plate or switch housing is coupled to the front surface of the frame; and the cover is disposed on the sub-plate for covering the circuit board.

In yet another aspect, the present invention provides a frame comprising a front surface, a back surface with a groove, and a frame central opening. The frame is capable of securely receiving and retaining a circuit board in said frame central opening and a radio frequency antenna of the circuit board to snugly fit into the groove to form a radio frequency communication system.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a back view of a radio frequency communication system, i.e., a wall switch assembly 10, according to an exemplary embodiment of the present invention;

FIG. 2 is an exploded view of the wall switch assembly 10, according to an exemplary embodiment of the invention; and

FIG. 3 is an exploded view of the wall switch assembly 10, according to another exemplary embodiment of the invention.

Like reference numerals refer to like parts throughout several views of the drawings.

### DETAILED DESCRIPTION OF THE INVENTION

The exemplary embodiments described herein detail for illustrative purposes are subject to many variations in structure and design. It should be emphasized, however that the present invention is not limited to a particular radio frequency communication system as shown and described. Rather, the principles of the present invention can be used with a variety of configurations and structural arrangements, e.g., for aesthetics, structural purposes, and/or for simplicity in shipping and storage. It is understood that various omissions, substitutions of equivalents are contemplated as circumstances may suggest or render expedient, but is intended to cover the application or implementation without departing from the spirit or scope of the claims of the present invention. As used herein, the terms “top,” “bottom,” and so forth, herein do not denote any order, quantity, or importance, but rather are used to distinguish one element from another, and the terms “a” and “an” herein do not denote a limitation of quantity, but rather denote the presence of at least one of the referenced item.

The present invention provides a radio frequency communication system, for example, a wall mountable control system, such as, a wall switch assembly, and more specifically the present invention provides a frame employed in a wall switch assembly capable of receiving a radio frequency antenna allowing the wall switch assembly to be operated and controlled remotely. The frame of the present invention provides an attractive and aesthetically pleasing appearance to the radio frequency communication system. The invention provides for a frame that has structural features to receive an entire length of the radio frequency antenna, such that, no portion of the radio frequency antenna is allowed to dangle outside, thereby enabling easy installation and low maintenance. Also, configuration of the radio frequency communication system provides the radio frequency antenna on an outside of the cover of a radio frequency communication system, away from the a negative field of other metallic members, thereby resulting in enhanced communication using the radio frequency communication system. Although the radio frequency communication system of the present invention, as described in detail herein below, is with regard to a wall switch assembly, it is not limited to such systems and the invention may be applicable to any kind of radio frequency communication system.

The present invention provides a frame for completely receiving a radio frequency antenna of a circuit board in radio frequency communication systems, such that, the radio frequency antenna is hidden from view, thus overcoming existing drawbacks in the prior art.

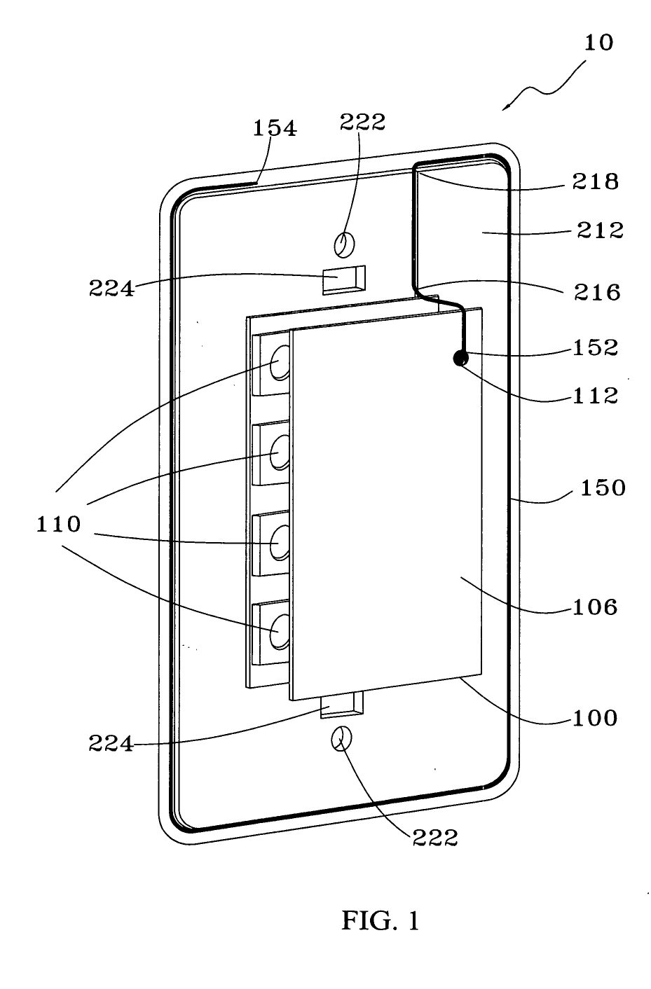

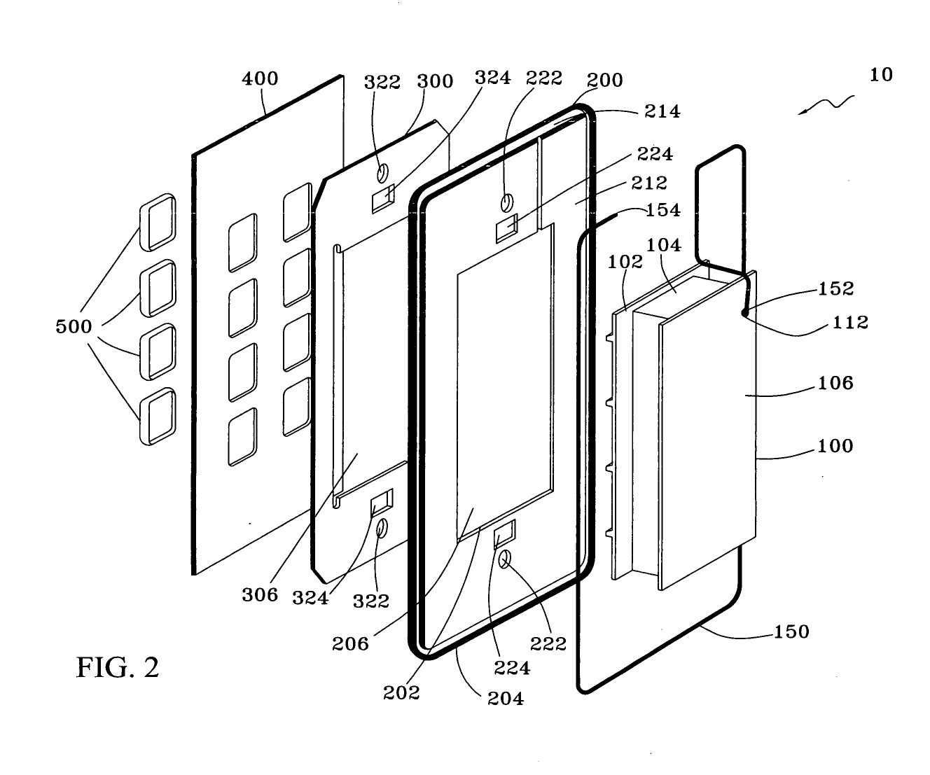

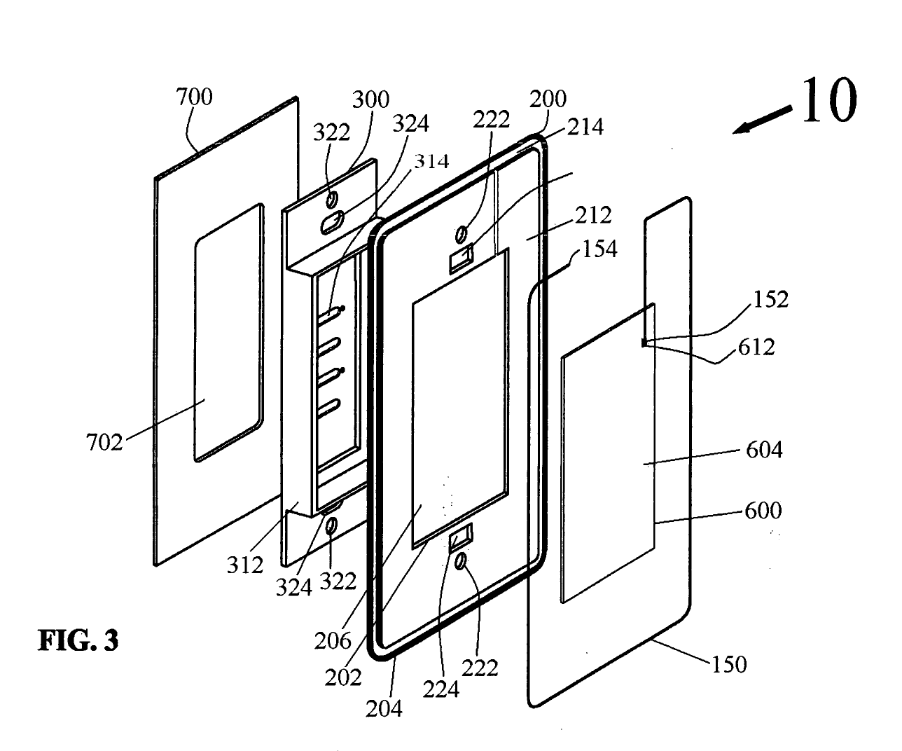

Referring now to FIGS. 1 and 2, in one embodiment, a wall switch assembly 10 comprises a circuit board 100 with a radio frequency antenna 150. The circuit board 100 may have a top member 102, a bottom member 106 and an intermediate member 104 interconnecting the top member 102 and the bottom member 106. Although the intermediate member 104 interconnects the top member 102 and the bottom member 106 in an I-beam configuration, as shown in FIG. 2, configurations other than that of I-beam is possible. The circuit board 100 has an internal circuitry (not shown) and a plurality of switches 110 disposed on the top member 102, the switches having a body extending out of the top member 102. The switches 110 may include pushbutton switches. In another embodiment, as shown in FIG. 3, a circuit board 600 may also be a single member circuit board having a front surface (not shown) with a plurality of switches, and a back surface 604, and the radio frequency antenna 150, thereby avoiding the need of the second board and the interconnection as shown in FIGS. 1 and 2.

The radio frequency antenna 150 is in form of a wire having a first end 152 and a second end 154. As shown in FIG. 2, the first end 152 is connected to the bottom member 106 of the circuit board 100 at a recess 112, the connection allowing the radio frequency antenna 150 to be in electrical operable communication with the internal circuitry of the circuit board 100. Although the radio frequency antenna is connected to the bottom member 106, as shown in FIG. 2, the radio frequency antenna 150 may be disposed on any of the members (i.e., top member 102, intermediate member 104, and bottom member 106) of the circuit board 100, such that, the radio frequency antenna 150 may be securely received in a frame of the wall switch assembly 10. Also as shown in FIG. 3, the first end 152 is connected to the back surface 604 at a recess 612, the connection allowing the radio frequency antenna 150 to be in electrical operable communication with the internal circuitry of the circuit board 600. Although the radio frequency antenna is connected to the back surface 604, as shown in FIG. 2, the radio frequency antenna 150 may be disposed anywhere on the circuit board 600, such that, the radio frequency antenna 150 may be securely received in a frame of the wall switch assembly 10.

The wall switch assembly 10 further comprises a frame 200 with a front surface (not shown) and a back surface 212, generally in the shape of a rectangular track, having an inner perimeter 202 and an outer perimeter 204 configuring a frame central opening 206. The frame central opening 206 has a sufficient area and thickness to securely receive the circuit board 100, 600. In one embodiment, the top member 102 of the circuit board 100 snugly fits into the frame central opening 206, such that, the switches 110 mounted on the top member 102, protrude out of the frame central opening from the front surface of the frame 200, and the intermediate and the bottom member 104, 106 protrude out of the back surface 212 of the frame 200. In another embodiment, the single member circuit board 600 may snugly fit into the frame central opening 206, such that the front surface of circuit board 600 along with the plurality of switches protrude out of the frame central opening 206 from the front surface of the frame 200, and the back surface 604 of the circuit board 600 with antenna 150 protrudes out of the back surface 212 of the frame 200.

The frame 200 has a groove 214 on the back surface 212 of the frame 200, the groove 214 beginning at a first location 216 on the inner perimeter 202 and extending up to a second location 218 on the outer perimeter 204, and running throughout the back surface 212 along the outer perimeter 204 (Refer FIG. 1). The radio frequency antenna 150 may be bent into a shape, such that, an entire length of the radio frequency antenna 150 is fitted into the groove 214, as illustrated in FIG. 1. In additional embodiments, the frame 200 may include a plurality of grooves [for example 214] running throughout in the back surface 212 along the outer perimeter 204 of the frame 200.

The wall switch assembly 10 further comprises a sub-plate 300. The sub-plate 300 is coupled to frame 200 using state of the art fastening means. As illustrated in FIGS. 2 and 3, the sub-plate 300 may have through holes 322 that align with through holes 222 on the frame 200, when the sub-plate 300 is disposed on the frame 200. The sub-plate 300 may be coupled to the frame 200 by passing suitable fasteners (e.g., bolts, nuts, screws, rivets and the like) through the holes 322 and the holes 222. Additionally, rectangular holes 324 on the sub-plate 300 and rectangular holes 224 on the frame 200 align with each other and suitable fasteners may be passed to further strengthen the coupling of the sub-plate 300 to the frame 200.

In one embodiment, as shown in FIG. 2, the sub-plate 300 has a sub-plate central opening 306 that aligns with the frame central opening 206, in the above coupled state. In this embodiment, the wall switch assembly 10 further comprises a cover 400 with button caps 500 to cover the sub-plate 300 and the circuit board 100 along with the top member 102, bottom member 106 along with their intermediate member 104. The button caps 500 fit onto the switches 110 on the top member 102 of the circuit board 100 and the whole system with the button caps 500 covering the switches 110 provide a plurality of switching buttons for operating the wall switch assembly 10.

In another embodiment, as shown in FIG. 3, the sub-plate 300 is in the form of a switch housing tab having a switch housing 312 capable of receiving the plurality of switches on the front surface of the circuit board 600 protruding out of the frame central opening 206. The switch housing 312 has a plurality of switch openings 314, such that, when the sub-plate 300 is coupled to the frame 200, a portion of the switches passes through the switch openings 314, and through a cover central opening 702 of a cover 700 (in this embodiment), to provide a plurality of switching buttons for operating the wall switch assembly 10.

The different components of the wall switch assembly 10, i.e., the frame 200, the sub-plate 300, the cover 400 with button caps 500, and the cover 700 may be made from a material individually selected from a group of conductive materials (e.g., sheet metal, like steel) and moldable non-conductive material (e.g., plastic). Preferably the frame 200 is made of non-conductive material.

The wall switch assembly 10 may be used to control the operation of a device (e.g., garage doors, lights, fans, audio or video components, shades, etc.) directly or remotely, with which it is associated. The wall switch assembly 10 provides a plurality of buttons, as discussed above. For example, in case of lighting control, the buttons include, but are not limited to, on, off, toggle, flash, timed on, raise, lower, dim, set scene, program button, and the like. Alternatively, other buttons or only some of the aforementioned buttons may be provided by the wall switch assembly 10. Optionally, the buttons may be color-coded or provided with identifying indicia to facilitate ease of use. The buttons may be pressed to perform a desired function, for example, pressing the open/close button momentarily closes a corresponding switch and initiates the opening/closing of a garage door. Application of constant pressure to any of the buttons is not needed, although in some instances, application of constant pressure and thus, closure, of a switch for an extended period provides an additional function to the wall switch assembly 10, such as raise/lower for dimming lights, increasing or decreasing volume, raise/lower a window shade, or closing a gate or door.

The purpose of the wall switch assembly 10 is to receive and/or transmit radio frequency signals from the radio frequency antenna 150 for directly or remotely controlling the operation of any electrical device. In cases of transmission, the antenna may be used to transmit signal to an operational electrical device, and in case of reception, can receive signal from a remotely operated gadget [for example, remote pad with buttons] and transfer the signal to an operational device in turn.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

1. A frame for a radio frequency communication system, said frame having a central opening and a groove, said frame capable of securely receiving and snugly retaining a circuit board of said radio frequency communication system in said central opening and capable of receiving a radio frequency antenna of said circuit board in said groove thereby enabling said radio frequency antenna to extend outside a perimeter of any metallic member of said radio frequency communication system and overcoming the negative field of said metallic members.

2. A radio frequency communication system comprising:
a circuit board with a radio frequency antenna;
a frame with a front surface, a back surface with a groove, and a frame central opening, said frame capable of securely receiving and retaining said circuit board in said frame central opening thereby enabling the radio frequency antenna to snugly fit into said groove;
a sub-plate coupled to said front surface of said frame; and
a cover disposed on said sub-plate for covering said circuit board.

3. The radio frequency communication system of claim 2, wherein said circuit board has a top member having a plurality of switches, a bottom member having said radio frequency antenna and an intermediate member connecting said top and bottom member.

4. The radio frequency communication system of claim 3, wherein upon receiving said circuit board in said frame central opening, said plurality of switches protrude out of said front surface of said frame, and said intermediate member and said bottom member with said radio frequency antenna protrude out of said back surface of said frame.

5. The radio frequency communication system of claim 2, wherein said circuit board is a single member circuit board having a front surface with a plurality of switches, a back surface and said radio frequency antenna.

6. The radio frequency communication system of claim 5, wherein upon receiving said circuit board in said frame central opening, said plurality of switches protrude out of said front surface of said frame and said back surface of circuit board and said radio frequency antenna protrudes out of said back surface of said frame.

7. The radio frequency communication system of claim 2, wherein said frame has an inner perimeter and an outer perimeter configuring said central opening.

8. The radio frequency communication system of claim 7, wherein said groove begins on said inner perimeter, extending to said outer perimeter and running along said outer perimeter throughout said back surface.

9. The radio frequency communication system of claim 2 wherein said sub-plate further has a plurality of through holes that align with a plurality of through holes on said frame, capable of receiving fastening means therethrough for coupling said sub-plate to said frame.

10. The radio frequency communication system of claim 2, wherein said sub-plate has a sub-plate central opening that aligns with said frame central opening.

11. The radio frequency communication system of claim 10, wherein said cover has a plurality of button caps on said cover capable of receiving switches on said circuit board thereby providing a plurality of switching buttons for operating said radio frequency communication system.

12. The radio frequency communication system of claim 2, wherein said sub-plate has a switch housing with a plurality of switch openings capable of receiving a plurality of switches on said circuit board, such that, a portion of said switches passes through said switch openings, and through a cover central opening of said cover, thereby providing a plurality of switching buttons for operating said radio frequency communication system.

13. A frame comprising:
an inner perimeter and an outer perimeter configuring a frame central opening;
a front surface, and a back surface with a groove, said groove beginning on said inner perimeter and extending to said outer perimeter and running along said outer perimeter throughout said back surface; said frame capable of securely receiving and retaining a circuit board in said frame central opening and a radio frequency antenna of said circuit board to snugly fit into said groove wholly to form a radio frequency communication system.

14. The frame of claim 13, wherein said circuit board comprises a top member with a plurality of switches, a bottom member with a radio frequency antenna and an intermediate member connecting said top member and said bottom member.

15. The frame of claim 14, wherein upon receiving said circuit board in said frame central opening, said plurality of switches protrude out of said front surface of said frame and said intermediate member and said bottom member with said radio frequency antenna protrudes out of said back surface of said frame.

16. The frame of claim 13, wherein said circuit board is a single member circuit board having a front surface with a plurality of switches, a back surface and a radio frequency antenna.

17. The frame of claim 16, wherein upon receiving said circuit board in said frame central opening, said plurality of switches protrude out of said front surface of said frame and said back surface of circuit board and said radio frequency antenna protrudes out of said back surface of said frame.

18. The frame of claim 13, wherein said radio frequency communication system further comprises a sub-plate coupled to said front surface of said frame.

19. The frame of claim 13, wherein said radio frequency communication system further comprises a cover disposed on said sub-plate for covering said circuit board having a plurality of switches.
